(19) United States
(12) Patent Application Publication
(10) Pub. No.: US 2026/0279350 A1
(43) Pub. Date: Sep. 17, 2026

(54) REFERENCE PICTURE RESAMPLING FOR VIDEO CODING

(71) Applicant: GUANGDONG OPPO MOBILE TELECOMMUNICATIONS CORP., LTD., Dongguan (CN)

(72) Inventors: Jonathan GAN, Palo Alto, CA (US); Yue YU, Palo Alto, CA (US); Haoping YU, Palo Alto, CA (US)

(21) Appl. No.: 19/681,645

(22) Filed: May 19, 2026

Related U.S. Application Data
(63) Continuation of application No. 18/857,157, filed on Apr. 21, 2023.
(60) Provisional application No. 63/363,386, filed on Apr. 21, 2022.

(51) Int. Cl. G10L 15/197; G10L 15/02; G10L 15/04; G10L 15/06; G10L 15/22; G10L 25/93; H04N 19/117; H04N 19/159; H04N 19/172; H04N 19/80

(52) U.S. Cl. CPC G10L 15/197; G10L 15/02; G10L 15/04; G10L 15/063; G10L 15/22; G10L 25/93; H04N 19/117; H04N 19/159; H04N 19/172; H04N 19/80; G10L 2015/025; G10L 2025/932

(57) ABSTRACT

In some embodiments, a video decoder decodes a video bitstream into video frames. A decoder decodes frames of a video from a video bitstream. The decoder further performs inter prediction to decode a current frame of the video by using the decoded frames as reference frames. Performing the inter prediction includes performing reference picture resampling by upsampling a reference frame for the current frame using one or more filters selected from a set of 32 6-tap interpolation filters. This set of interpolation filters is also used for interpolating chroma components for motion compensation. The decoded frame and the decoded current frame are output for display.

### CROSS-REFERENCE TO RELATED APPLICATIONS

This is a continuation application of U.S. patent application Ser. No. 18/857,157 filed on Oct. 15, 2024, which is a national stage application of International Patent Application No. PCT/US2023/019386, filed on Apr. 21, 2023, which claims priority to U.S. Provisional Application No. 63/363,386, entitled “Use of Chroma Interpolation Filter for Reference Picture Resampling,” filed on Apr. 21, 2022, the disclosures of which are hereby incorporated in their entirety by reference.

### TECHNICAL FIELD

This disclosure relates generally to video processing. Specifically, the present disclosure involves using chroma interpolation filter for reference picture resampling in video coding.

### BACKGROUND

The ubiquitous camera-enabled devices, such as smartphones, tablets, and computers, have made it easier than ever to capture videos or images. However, the amount of data for even a short video can be substantially large. Video coding technology (including video encoding and decoding) allows video data to be compressed into smaller sizes thereby allowing various videos to be stored and transmitted. Video coding has been used in a wide range of applications, such as digital TV broadcast, video transmission over the Internet and mobile networks, real-time applications (e.g., video chat, video conferencing), DVD and Blu-ray discs, and so on. To reduce the storage space for storing a video and/or the network bandwidth consumption for transmitting a video, it is desired to improve the efficiency of the video coding scheme.

### SUMMARY

Some embodiments involve using chroma interpolation filter for reference picture resampling in video coding. In one example, a method for decoding a video from a video bitstream including decoding one or more frames of the video from the video bitstream, and performing inter prediction to decode a current frame of the video by using the one or more decoded frames as reference frames. Performing the inter prediction includes performing reference picture resampling by upsampling a reference frame for the current frame using at least a filter selected from a set of 32 6-tap interpolation filters. The method further includes causing the decoded one or more frames and the decoded current frame to be displayed.

In another example, a non-transitory computer-readable medium has program code that is stored thereon, and the program code is executable by one or more processing devices for performing operations. The operations include decoding one or more frames of a video from a video bitstream and performing inter prediction to decode a current frame of the video by using the one or more decoded frames as reference frames. Performing the inter prediction includes performing reference picture resampling by upsampling a reference frame for the current frame using at least a filter selected from a set of 32 6-tap interpolation filters. The operations further include causing the decoded one or more frames and the decoded current frame to be displayed.

In yet another example, a system includes a processing device and a non-transitory computer-readable medium communicatively coupled to the processing device. The processing device is configured to execute program code stored in the non-transitory computer-readable medium and thereby perform operations. The operations include decoding one or more frames of a video from a video bitstream; and performing inter prediction to decode a current frame of the video by using the one or more decoded frames as reference frames. Performing the inter prediction includes performing reference picture resampling by upsampling a reference frame for the current frame using at least a filter selected from a set of 32 6-tap interpolation filters. The operations further include causing the decoded one or more frames and the decoded current frame to be displayed.

In another example, a method for encoding a video includes accessing a plurality of frames of the video; and performing inter prediction for the plurality of frames to generate prediction residuals for the plurality of frames. Performing the inter prediction includes performing reference picture resampling by upsampling a reference frame for a current frame in the plurality of frames using at least a filter selected from a set of 32 6-tap interpolation filters. The method further includes encoding the prediction residuals for the plurality of frames into a bitstream representing the video.

In another example, a non-transitory computer-readable medium has program code that is stored thereon, and the program code is executable by one or more processing devices for performing operations. The operations include accessing a plurality of frames of a video; and performing inter prediction for the plurality of frames to generate prediction residuals for the plurality of frames. Performing the inter prediction includes performing reference picture resampling by upsampling a reference frame for a current frame in the plurality of frames using at least a filter selected from a set of 32 6-tap interpolation filters. The operations further include encoding the prediction residuals for the plurality of frames into a bitstream representing the video.

In yet another example, a system includes a processing device and a non-transitory computer-readable medium communicatively coupled to the processing device. The processing device is configured to execute program code stored in the non-transitory computer-readable medium and thereby perform operations. The operations include accessing a plurality of frames of a video; and performing inter prediction for the plurality of frames to generate prediction residuals for the plurality of frames. Performing the inter prediction includes performing reference picture resampling by upsampling a reference frame for a current frame in the plurality of frames using at least a filter selected from a set of 32 6-tap interpolation filters. The operations further include encoding the prediction residuals for the plurality of frames into a bitstream representing the video.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a block diagram showing an example of a video encoder configured to implement embodiments presented herein.

FIG. 2 is a block diagram showing an example of a video decoder configured to implement embodiments presented herein.

FIG. 3 depicts an example of a coding tree unit division of a picture in a video, according to some embodiments of the present disclosure.

FIG. 4 depicts an example of a coding unit division of a coding tree unit, according to some embodiments of the present disclosure.

FIG. 5A illustrates an example of interpolations for reference picture resampling for a given upsampling ratio, according to some embodiments of the present disclosure.

FIG. 5B illustrates another example of interpolations for reference picture resampling for a given upsampling ratio, according to some embodiments of the present disclosure.

FIG. 6 depicts an example of a process for determining interpolation filters for reference picture resampling, according to some embodiments of the present disclosure.

FIG. 7 depicts another example of a process for encoding a video, according to some embodiments of the present disclosure.

FIG. 8 depicts another example of a process for decoding a video, according to some embodiments of the present disclosure.

FIG. 9 depicts an example of a computing system that can be used to implement some embodiments of the present disclosure.

FIG. 10 depicts an example of a process for identifying one or more interpolation filters from a set of chroma interpolation filters, according to some embodiments of the present disclosure.

### DETAILED DESCRIPTION

Various embodiments provide mechanisms for using chroma interpolation filters for reference picture resampling in video coding. As discussed above, more and more video data are being generated, stored, and transmitted. It is beneficial to increase the efficiency of video coding technology. One way to do so is through inter-prediction where the prediction of video pixels or samples in a current frame to be decoded uses pixels or samples from other frames which have already been reconstructed (referred to as “reference frames” or “reference pictures”). To perform the inter prediction, it often involves, for example during the motion compensation, using an interpolation filter to determine the prediction samples at the fractional-pel positions in the reference frame using values of samples at integer-pel positions. In some cases, a reference frame may have a different resolution from the current frame. In those cases, the reference frame is re-sampled to the same resolution as the current frame, such as upsampling a low-resolution reference frame to match the resolution of the current frame. In upsampling, samples at the fractional-pel positions are interpolated using value of samples at integer-pel positions. Existing interpolation filters for reference picture resampling use 4-tap filters for upsampling the chroma component of the reference picture which may provide inaccurate interpolation results, leading to low coding efficiency.

Various embodiments described herein address these problems by utilizing 6-tap interpolation filters for reference picture resampling which can provide better and more accurate interpolation results. In some embodiments, the video encoder or decoder re-uses a set of 32 6-tap chroma interpolation filters that are used for motion compensation to perform the reference picture upsampling for the video. To select a filter from the set of 32 6-tap chroma interpolation filters, the video coder can determine the upsampling ratio based on the resolutions of the current frame and the reference frame and the upsampling locations. The interpolation filter can be selected from the set of 32 6-tap chroma interpolation filters by determining a position among 32 positions corresponding to the 32 interpolation filters that is closest to a fractional portion of the upsampled locations and selecting an interpolation filter from the set of 32 interpolation filters that corresponds to the determined position.

As described herein, some embodiments provide improvements in video coding efficiency through using 6-tap interpolation filters for reference picture resampling and re-using a set of 32 6-tap chroma interpolation filters configured for motion compensation. By using 6-tap interpolation filters to replace the existing 4-tap filters, a more accurate interpolation can be achieved for upsampling because more neighboring samples are considered when generating an interpolated sample. As a result, the values of inter prediction residuals are smaller and the video coding efficiency is increased. In addition, re-using the motion compensation interpolation filters for reference picture resampling reduces the storage usage of the video encoder and decoder. The techniques can be an effective coding tool in future video coding standards.

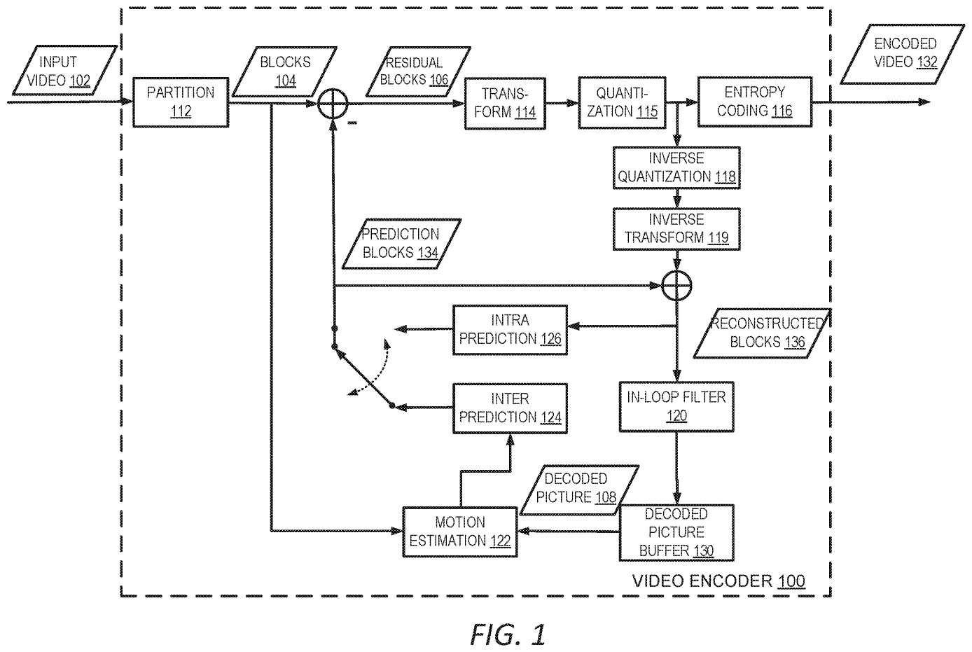

Referring now to the drawings, FIG. 1 is a block diagram showing an example of a video encoder 100 configured to implement embodiments presented herein. In the example shown in FIG. 1, the video encoder 100 includes a partition module 112, a transform module 114, a quantization module 115, an inverse quantization module 118, an inverse transform module 119, an in-loop filter module 120, an intra prediction module 126, an inter prediction module 124, a motion estimation module 122, a decoded picture buffer 130, and an entropy coding module 116.

The input to the video encoder 100 is an input video 102 containing a sequence of pictures (also referred to as frames or images). In a block-based video encoder, for each of the pictures, the video encoder 100 employs a partition module 112 to partition the picture into blocks 104, and each block contains multiple pixels. The blocks may be macroblocks, coding tree units, coding units, prediction units, and/or prediction blocks. One picture may include blocks of different sizes and the block partitions of different pictures of the video may also differ. Each block may be encoded using different predictions, such as intra prediction or inter prediction or intra and inter hybrid prediction.

Usually, the first picture of a video signal is an intra-coded picture, which is encoded using only intra prediction. In the intra prediction mode, a block of a picture is predicted using only data that has been encoded from the same picture. A picture that is intra-coded can be decoded without information from other pictures. To perform the intra-prediction, the video encoder 100 shown in FIG. 1 can employ the intra prediction module 126. The intra prediction module 126 is configured to use reconstructed samples in reconstructed blocks 136 of neighboring blocks of the same picture to generate an intra-prediction block (the prediction block 134). The intra prediction is performed according to an intra-prediction mode selected for the block. The video encoder 100 then calculates the difference between block 104 and the intra-prediction block 134. This difference is referred to as residual block 106.

To further remove the redundancy from the block, the residual block 106 is transformed by the transform module 114 into a transform domain by applying a transform on the samples in the block. Examples of the transform may include, but are not limited to, a discrete cosine transform (DCT) or discrete sine transform (DST). The transformed values may be referred to as transform coefficients representing the residual block in the transform domain. In some examples, the residual block may be quantized directly without being transformed by the transform module 114. This is referred to as a transform skip mode.

The video encoder 100 can further use the quantization module 115 to quantize the transform coefficients to obtain quantized coefficients. Quantization includes dividing a sample by a quantization step size followed by subsequent rounding, whereas inverse quantization involves multiplying the quantized value by the quantization step size. Such a quantization process is referred to as scalar quantization. Quantization is used to reduce the dynamic range of video samples (transformed or non-transformed) so that fewer bits are used to represent the video samples.

The quantization of coefficients/samples within a block can be done independently and this kind of quantization method is used in some existing video compression standards, such as H.264 or advance video codec (AVC), and H.265 or high efficiency video coding (HEVC). For an N-by-M block, some scan order may be used to convert the 2D coefficients of a block into a 1-D array for coefficient quantization and coding. Quantization of a coefficient within a block may make use of the scan order information. For example, the quantization of a given coefficient in the block may depend on the status of the previous quantized value along the scan order. In order to further improve the coding efficiency, more than one quantizer may be used. Which quantizer is used for quantizing a current coefficient depends on the information preceding the current coefficient in the encoding/decoding scan order. Such a quantization approach is referred to as dependent quantization.

The degree of quantization may be adjusted using the quantization step sizes. For instance, for scalar quantization, different quantization step sizes may be applied to achieve finer or coarser quantization. Smaller quantization step sizes correspond to finer quantization, whereas larger quantization step sizes correspond to coarser quantization. The quantization step size can be indicated by a quantization parameter (QP). Quantization parameters are provided in an encoded bitstream of the video such that the video decoder can access and apply the quantization parameters for decoding.

The quantized samples are then coded by the entropy coding module 116 to further reduce the size of the video signal. The entropy encoding module 116 is configured to apply an entropy encoding algorithm to the quantized samples. In some examples, the quantized samples are binarized into binary bins and coding algorithms further compress the binary bins into bits. Examples of the binarization methods include, but are not limited to, a combined truncated Rice (TR) and limited k-th order Exp-Golomb (EGk) binarization, and k-th order Exp-Golomb binarization. Examples of the entropy encoding algorithm include, but are not limited to, a variable length coding (VLC) scheme, a context adaptive VLC scheme (CAVLC), an arithmetic coding scheme, a binarization, a context adaptive binary arithmetic coding (CABAC), syntax-based context-adaptive binary arithmetic coding (SBAC), probability interval partitioning entropy (PIPE) coding, or other entropy encoding techniques. The entropy-coded data is added to the bitstream of the output encoded video 132.

As discussed above, reconstructed blocks 136 from neighboring blocks are used in the intra-prediction of blocks of a picture. Generating the reconstructed block 136 of a block involves calculating the reconstructed residuals of this block. The reconstructed residual can be determined by applying inverse quantization and inverse transform to the quantized residual of the block. The inverse quantization module 118 is configured to apply the inverse quantization to the quantized samples to obtain de-quantized coefficients. The inverse quantization module 118 applies the inverse of the quantization scheme applied by the quantization module 115 by using the same quantization step size as the quantization module 115. The inverse transform module 119 is configured to apply the inverse transform of the transform applied by the transform module 114 to the de-quantized samples, such as inverse DCT or inverse DST. The output of the inverse transform module 119 is the reconstructed residuals for the block in the pixel domain. The reconstructed residuals can be added to the prediction block 134 of the block to obtain a reconstructed block 136 in the pixel domain. For blocks where the transform is skipped, the inverse transform module 119 is not applied to those blocks. The de-quantized samples are the reconstructed residuals for the blocks.

Blocks in subsequent pictures following the first intra-predicted picture can be coded using either inter prediction or intra prediction. In inter-prediction, the prediction of a block in a picture is from one or more previously encoded video pictures. To perform inter prediction, the video encoder 100 uses an inter prediction module 124. The inter prediction module 124 is configured to perform motion compensation for a block based on the motion estimation provided by the motion estimation module 122.

The motion estimation module 122 compares a current block 104 of the current picture with decoded reference pictures 108 for motion estimation. The decoded reference pictures 108 are stored in a decoded picture buffer 130. The motion estimation module 122 selects a reference block from the decoded reference pictures 108 that best matches the current block. The motion estimation module 122 further identifies an offset between the position (e.g., x, y coordinates) of the reference block and the position of the current block. This offset is referred to as the motion vector (MV) and is provided to the inter prediction module 124 along with the selected reference block. In some cases, multiple reference blocks are identified for the current block in multiple decoded reference pictures 108. Therefore, multiple motion vectors are generated and provided to the inter prediction module 124 along with the corresponding reference blocks.

The inter prediction module 124 uses the motion vector(s) along with other inter-prediction parameters to perform motion compensation to generate a prediction of the current block, i.e., the inter prediction block 134. For example, based on the motion vector(s), the inter prediction module 124 can locate the prediction block(s) pointed to by the motion vector(s) in the corresponding reference picture(s). If there is more than one prediction block, these prediction blocks are combined with some weights to generate a prediction block 134 for the current block.

For inter-predicted blocks, the video encoder 100 can subtract the inter-prediction block 134 from block 104 to generate the residual block 106. The residual block 106 can be transformed, quantized, and entropy coded in the same way as the residuals of an intra-predicted block discussed above. Likewise, the reconstructed block 136 of an inter-predicted block can be obtained through inverse quantizing, inverse transforming the residual, and subsequently combining with the corresponding prediction block 134.

To obtain the decoded picture 108 used for motion estimation, the reconstructed block 136 is processed by an in-loop filter module 120. The in-loop filter module 120 is configured to smooth out pixel transitions thereby improving the video quality. The in-loop filter module 120 may be configured to implement one or more in-loop filters, such as a de-blocking filter, a sample-adaptive offset (SAO) filter, an adaptive loop filter (ALF), etc.

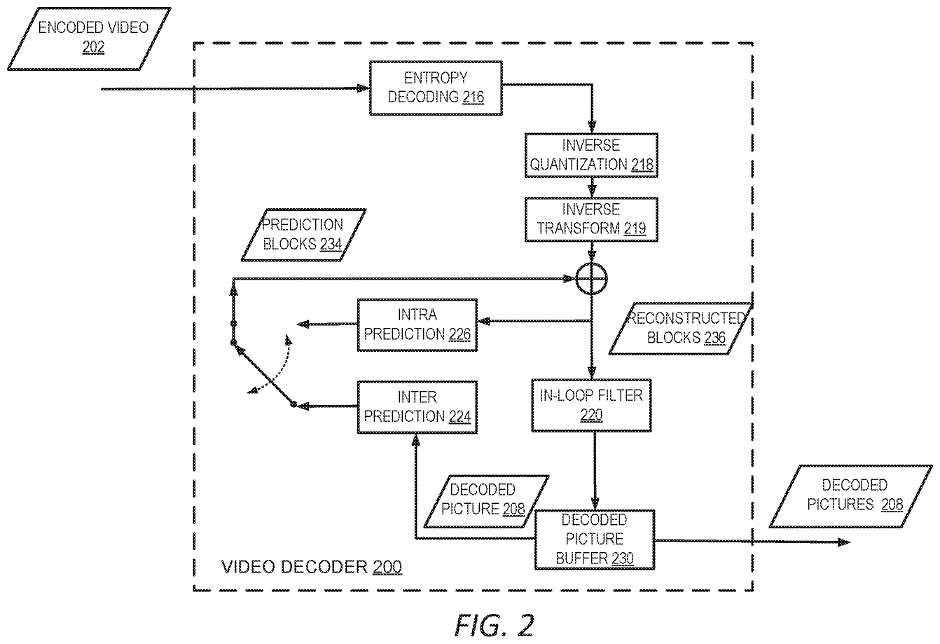

FIG. 2 depicts an example of a video decoder 200 configured to implement the embodiments presented herein. The video decoder 200 processes an encoded video 202 in a bitstream and generates decoded pictures 208. In the example shown in FIG. 2, the video decoder 200 includes an entropy decoding module 216, an inverse quantization module 218, an inverse transform module 219, an in-loop filter module 220, an intra prediction module 226, an inter prediction module 224, and a decoded picture buffer 230.

The entropy decoding module 216 is configured to perform entropy decoding of the encoded video 202. The entropy decoding module 216 decodes the quantized coefficients, coding parameters including intra prediction parameters and inter prediction parameters, and other information. In some examples, the entropy decoding module 216 decodes the bitstream of the encoded video 202 to binary representations and then converts the binary representations to quantization levels of the coefficients. The entropy-decoded coefficient levels are then inverse quantized by the inverse quantization module 218 and subsequently inverse transformed by the inverse transform module 219 to the pixel domain. The inverse quantization module 218 and the inverse transform module 219 function similarly to the inverse quantization module 118 and the inverse transform module 119, respectively, as described above with respect to FIG. 1. The inverse-transformed residual block can be added to the corresponding prediction block 234 to generate a reconstructed block 236. For blocks where the transform is skipped, the inverse transform module 219 is not applied to those blocks. The de-quantized samples generated by the inverse quantization module 118 are used to generate the reconstructed block 236.

The prediction block 234 of a particular block is generated based on the prediction mode of the block. If the coding parameters of the block indicate that the block is intra predicted, the reconstructed block 236 of a reference block in the same picture can be fed into the intra prediction module 226 to generate the prediction block 234 for the block. If the coding parameters of the block indicate that the block is inter-predicted, the prediction block 234 is generated by the inter prediction module 224. The intra prediction module 226 and the inter prediction module 224 function similarly to the intra prediction module 126 and the inter prediction module 124 of FIG. 1, respectively.

As discussed above with respect to FIG. 1, the inter prediction involves one or more reference pictures. The video decoder 200 generates the decoded pictures 208 for the reference pictures by applying the in-loop filter module 220 to the reconstructed blocks of the reference pictures. The decoded pictures 208 are stored in the decoded picture buffer 230 for use by the inter prediction module 224 and also for output.

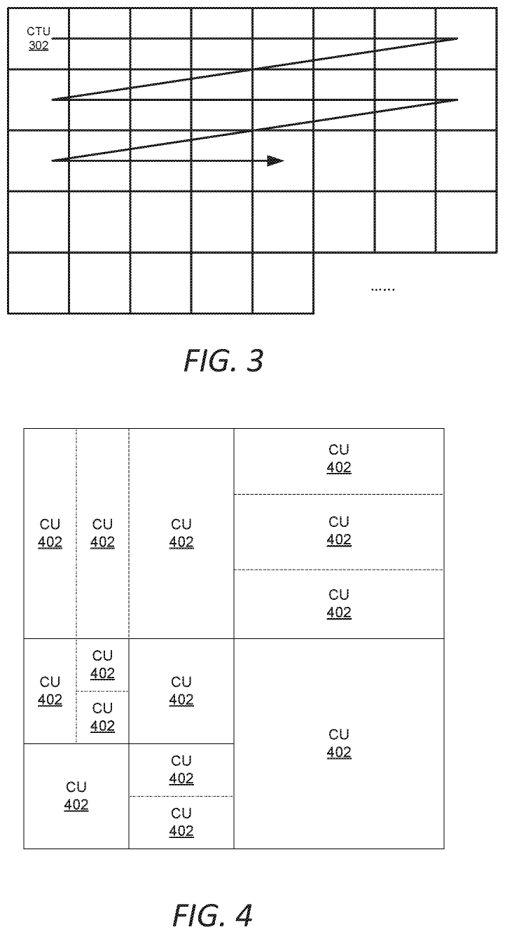

Referring now to FIG. 3, FIG. 3 depicts an example of a coding tree unit division of a picture in a video, according to some embodiments of the present disclosure. As discussed above with respect to FIGS. 1 and 2, to encode a picture of a video, the picture is divided into blocks, such as the CTUs (Coding Tree Units) 302 in versatile video coding (VVC), as shown in FIG. 3. For example, the CTUs 302 can be blocks of 128×128 pixels. The CTUs are processed according to an order, such as the order shown in FIG. 3. In some examples, each CTU 302 in a picture can be partitioned into one or more CUs (Coding Units) 402 as shown in FIG. 4, which can be further partitioned into prediction units or transform units (TUs) for prediction and transformation. Depending on the coding schemes, a CTU 302 may be partitioned into CUs 402 differently. For example, in VVC, the CUs 402 can be rectangular or square, and can be coded without further partitioning into prediction units or transform units. Each CU 402 can be as large as its root CTU 302 or be subdivisions of a root CTU 302 as small as 4×4 blocks. As shown in FIG. 4, a division of a CTU 302 into CUs 402 in VVC can be quadtree splitting or binary tree splitting or ternary tree splitting. In FIG. 4, solid lines indicate quadtree splitting and dashed lines indicate binary or ternary tree splitting.

### Motion Compensation

A tool employed in the hybrid video coding system, such as VVC and HEVC, is the prediction of video pixels or samples in a current frame to be decoded using pixels or samples from other frames which have already been reconstructed. Coding tools following this architecture are commonly referred to as “inter-prediction” tools, and the reconstructed frames may be called “reference frames.” For stationary video scenes, inter-prediction for pixels or samples in the current frame can be achieved by decoding and using the collocated pixels or samples from the reference frames. However, video scenes containing motion necessitate the use of inter-prediction tools with motion compensation. For example, a current block of samples in the current frame may be predicted from a “prediction block” of samples from the reference frame, which is determined by firstly decoding a “motion vector” that signals the position of the prediction block in the reference frame relative to the position of the current block in the current frame. More sophisticated inter-prediction tools are used to exploit video scenes with complex motion, such as occlusion, or affine motion.

### Interpolation

In cases where the position of the prediction block relative to the position of the current block is expressed in integer number of samples, the prediction block samples may be obtained directly from the corresponding sample positions in the reference frame. However, in general it is likely that the actual motion in the scene is equivalent to a non-integer number of samples. In such cases a prediction block may be determined using fractional pixel (fractional-pel) motion compensation. To determine the prediction blocks samples, the value of samples at the desired fractional-pel positions are interpolated from available samples at integer-pel positions. The interpolation method is selected by balancing design requirements including complexity, motion vector precision, interpolation error, and robustness to noise. Despite these trade-offs, prediction from interpolated prediction blocks utilising fractional-pel motion compensation has been found to be advantageous compared to only allowing prediction blocks with integer-pel motion compensation.

For ease of computation, most interpolation methods may be implemented by convolution of the available reference frame samples with a linear, shift-invariant set of coefficients. Such an operation is also known as filtering. Video coding standards have typically implemented interpolation of the two-dimensional prediction block by the separable application of one-dimensional filtering in the vertical and horizontal directions. To allow signaling of the motion vector information, motion vectors are typically limited to a multiple of a fractional-pel precision. For example, motion vectors for luma prediction may be limited to a multiple of 1/16th pel precision.

In the interpolation paradigm described above, determination of the prediction block samples is governed by a limited set of interpolation filters. For the example of 1/16th pel precision, the total number of filters required for luma interpolation would be 16. The individual filters in the filter set may be referred to by their phases, which can be numbered from 0 to P−1 for a filter set designed for 1/P pel precision. The individual filters in a filter set H can be labelled as h₀, h₁, . . . h_{P-1}. For regularity of implementation, each of the filters typically has the same length N. The filter length may also be referred to as the support of the filter. The individual filter coefficients, which may also be referred to as taps, are related to a particular filter at phase k by:

$${h}_{k} = \{ {h}_{k} [ 0 ] , {h}_{k} [ 1 ] , … {h}_{k} [ N - 1 ] \} . \qquad ( 1 )$$

The definition of an interpolation process for the prediction block can be simplified to the design of a fixed set of P interpolation filters, each with N coefficients. Furthermore, a number of these filters are redundant. Consider that interpolating with the h_{P-1} filter is equivalent to interpolating with a hypothetical h₋₁ filter (that is, a filter with phase −1) but over a support that is shifted forward by one pixel. Further, the h₋₁ filter may be implemented by the mirror image of the h₁ filter. Therefore, the filter design requirements can be further simplified to designing the set of filters with phase 0 through to P/2. The remaining filters may be defined in terms of the first P/2 phases:

$${h}_{0} = \{ {h}_{0} [ 0 ] , {h}_{0} [ 1 ] , … {h}_{0} [ N - 1 ] \} \qquad ( 2 )$$

$${h}_{1} = \{ {h}_{1} [ 0 ] , {h}_{1} [ 1 ] , … {h}_{1} [ N - 1 ] \}$$

$$⋮$$

$${h}_{\frac{P}{2}} = \{ {h}_{\frac{P}{2}} [ 0 ] , {h}_{\frac{P}{2}} [ 1 ] , … {h}_{\frac{P}{2}} [ N - 1 ] \}$$

$$⋮$$

$${h}_{P - 2} = \{ {h}_{2} [ N - 1 ] , {h}_{2} [ N - 2 ] , … {h}_{2} [ 0 ] \}$$

$${h}_{P - 1} = \{ {h}_{1} [ N - 1 ] , {h}_{1} [ N - 2 ] , … {h}_{1} [ 0 ] \}$$

The filter design method selected is dependent on the trade-offs under consideration for a particular video standard. Moreover, the filter design for luma interpolation filters may be different from the filter design for chroma interpolation filters, as the different characteristics of color components may suit different filters. In some examples, luma interpolation filters are based upon a windowed sinc filter design, while chroma interpolation filters are based upon a DCT filter design. For example, 12-tap luma filters and 6-tap chroma filters with coefficients as shown in Table 1 and Table 2, respectively, can be used. For luma component, there are 16 filters as shown in Table 1, which implement interpolation in increments of 1/16 sample shift. In Table 1, each row represents the coefficients of the 12-tap filter at the corresponding position. For example, the k-th row (k=0, . . . , 15) of Table 1 represents the coefficients of the 12-tap filter at the position k/16.

TABLE 1
Coefficients for 12-tap luma interpolation filters

| Position | Coefficients |
|---|---|
| 0/16 | {0, 0, 0, 0, 0, 256, 0, 0, 0, 0, 0, 0,}, |
| 1/16 | {−1, 2, −3, 6, −14, 254, 16, −7, 4, −2, 1, 0,}, |
| 2/16 | {−1, 3, −7, 12, −26, 249, 35, −15, 8, −4, 2, 0,}, |
| 3/16 | {−2, 5, −9, 17, −36, 241, 54, −22, 12, −6, 3, −1,}, |
| 4/16 | {−2, 5, −11, 21, −43, 230, 75, −29, 15, −8, 4, −1,}, |
| 5/16 | {−2, 6, −13, 24, −48, 216, 97, −36, 19, −10, 4, −1,}, |
| 6/16 | {−2, 7, −14, 25, −51, 200, 119, −42, 22, −12, 5, −1,}, |
| 7/16 | {−2, 7, −14, 26, −51, 181, 140, −46, 24, −13, 6, −2,}, |
| 8/16 | {−2, 6, −13, 25, −50, 162, 162, −50, 25, −13, 6, −2,}, |
| 9/16 | {−2, 6, −13, 24, −46, 140, 181, −51, 26, −14, 7, −2,}, |
| 10/16 | {−1, 5, −12, 22, −42, 119, 200, −51, 25, −14, 7, −2,}, |
| 11/16 | {−1, 4, −10, 19, −36, 97, 216, −48, 24, −13, 6, −2,}, |
| 12/16 | {−1, 4, −8, 15, −29, 75, 230, −43, 21, −11, 5, −2,}, |
| 13/16 | {−1, 3, −6, 12, −22, 54, 241, −36, 17, −9, 5, −2,}, |
| 14/16 | {0, 2, −4, 8, −15, 35, 249, −26, 12, −7, 3, −1,}, |
| 15/16 | {0, 1, −2, 4, −7, 16, 254, −14, 6, −3, 2, −1,}. |

For chroma component, there are 32 filters as shown in Table 2, which implement interpolation in increments of 1/32 sample shift. In Table 2, each row represents the coefficients of the 6-tap filter at the corresponding position. For example, the k-th row (k=0, 31) of Table 2 represents the coefficients of the 6-tap filter at the position k/32.

TABLE 2
Coefficients for 6-tap chroma interpolation filters

| Position | Coefficients |
|---|---|
| 0/32 | {0, 0, 256, 0, 0, 0}, |
| 1/32 | {1, −6, 256, 7, −2, 0}, |
| 2/32 | {2, −11, 253, 15, −4, 1}, |
| 3/32 | {3, −16, 251, 23, −6, 1}, |
| 4/32 | {4, −21, 248, 33, −10, 2}, |
| 5/32 | {5, −25, 244, 42, −12, 2}, |
| 6/32 | {7, −30, 239, 53, −17, 4}, |
| 7/32 | {7, −32, 234, 62, −19, 4}, |
| 8/32 | {8, −35, 227, 73, −22, 5}, |
| 9/32 | {9, −38, 220, 84, −26, 7}, |
| 10/32 | {10, −40, 213, 95, −29, 7}, |
| 11/32 | {10, −41, 204, 106, −31, 8}, |
| 12/32 | {10, −42, 196, 117, −34, 9}, |
| 13/32 | {10, −41, 187, 127, −35, 8}, |
| 14/32 | {11, −42, 177, 138, −38, 10}, |
| 15/32 | {10, −41, 168, 148, −39, 10}, |
| 16/32 | {10, −40, 158, 158, −40, 10}, |
| 17/32 | {10, −39, 148, 168, −41, 10}, |
| 18/32 | {10, −38, 138, 177, −42, 11}, |
| 19/32 | {8, −35, 127, 187, −41, 10}, |
| 20/32 | {9, −34, 117, 196, −42, 10}, |
| 21/32 | {8, −31, 106, 204, −41, 10}, |
| 22/32 | {7, −29, 95, 213, −40, 10}, |
| 23/32 | {7, −26, 84, 220, −38, 9}, |
| 24/32 | {5, −22, 73, 227, −35, 8}, |
| 25/32 | {4, −19, 62, 234, −32, 7}, |
| 26/32 | {4, −17, 53, 239, −30, 7}, |
| 27/32 | {2, −12, 42, 244, −25, 5}, |
| 28/32 | {2, −10, 33, 248, −21, 4}, |
| 29/32 | {1, −6, 23, 251, −16, 3}, |
| 30/32 | {1, −4, 15, 253, −11, 2}, |
| 31/32 | {0, −2, 7, 256, −6, 1}. |

### Reference Picture Resampling

For real-time communication use cases, rate-control mechanisms are implemented so that communication can continue over unstable network connections. One mechanism for achieving this is through dynamic resolution adjustment. That is, when network capacity is reduced, the real-time communication system may send low resolution video instead to achieve bitrate savings. In older video standards such as AVC or HEVC this feature was only achievable by beginning the resolution change with transmission of a so-called “IDR” or “IRAP” frame, which are encoded without dependency on previously decoded frames. Such independent frames are significantly larger in bitrate to send because they cannot make use of efficient inter-prediction tools including motion compensation.

In VVC, this restriction was removed by the adoption of the Reference Picture Resampling (RPR) tool. In RPR, reference pictures may be resampled to match the resolution of the current frame, meaning that inter-prediction tools can make use of reference pictures with a different resolution. This allows resolution switch to occur seamlessly without needing to transmit an IDR or IRAP frame.

To implement RPR, the resampling process must be defined normatively. For cases where the reference picture has lower resolution than the current picture, the reference picture is upsampled. For cases where the reference picture has higher resolution than the current picture, the reference picture is downsampled. The existing RPR implementations use 4-tap filters for upsampling the chroma component of the reference picture. These 4-tap filters may not provide accurate upsampling results.

To achieve more accurate reference picture upsampling, chroma interpolation filters can be reused for the reference picture resampling. Let the sample values of a chroma component of the reference picture be x[i,j] for integer values of i,j. In an example of translational motion compensation, it may be required to interpolate the chroma component at non-integer locations. However, the sample spacing is still unit distance. For example, the

$$[ \begin{matrix}A + a , B + b & 1 + A + a , B + b & ⋯ & X - 1 + A + a , B + b \\ A + a , 1 + B + b & 1 + A + a , 1 + B + b & ⋯ & X - 1 + A + a , 1 + B + b \\ ⋮ & ⋱ & ⋱ & ⋮ \\ A + a , Y - 1 + B + b & 1 + A + a , Y - 1 + B + b & ⋯ & X - 1 + A + a , Y - 1 + B + b\end{matrix} ]$$

Where A, B are the integer components of the location of the first sample, a, b are the non-integer components of the location of the first sample, and X, Y is the size of the block.

For cases where the reference picture has a lower resolution than the current picture, the requirement to upsample the chroma component may be reformulated as sampling the signal x with denser sample spacing (i.e., spacing between the samples of less than unit distance), some of which must necessarily be at non-integer sample locations. Because chroma interpolation filters are already defined for motion compensation, it is advantageous to re-use these filters to reduce storage costs for implementation of the video codec. As long as the samplings of x are at non-integer locations in 1/32 sample precision, there will be an associated chroma interpolation filter suitable for performing RPR upsampling.

In one embodiment, the entire reference picture is upsampled by a known ratio r, and the resulting upsampled reference picture is stored in a buffer. The value of r is calculated by the ratio between the resolution of the current picture and the resolution of the reference picture. The upsampled reference picture samples are then used as input to inter-prediction tools used to predict the current picture.

The exact upsampled locations to be interpolated may depend on sampling convention. For instance, if r=2, then in one example the upsampled locations along the i dimension (horizontal dimension) can be:

$$i = 0 , 0.5 , 1 , 1.5 , 2 , 2.5 … , W - 1 , W - 0.5$$

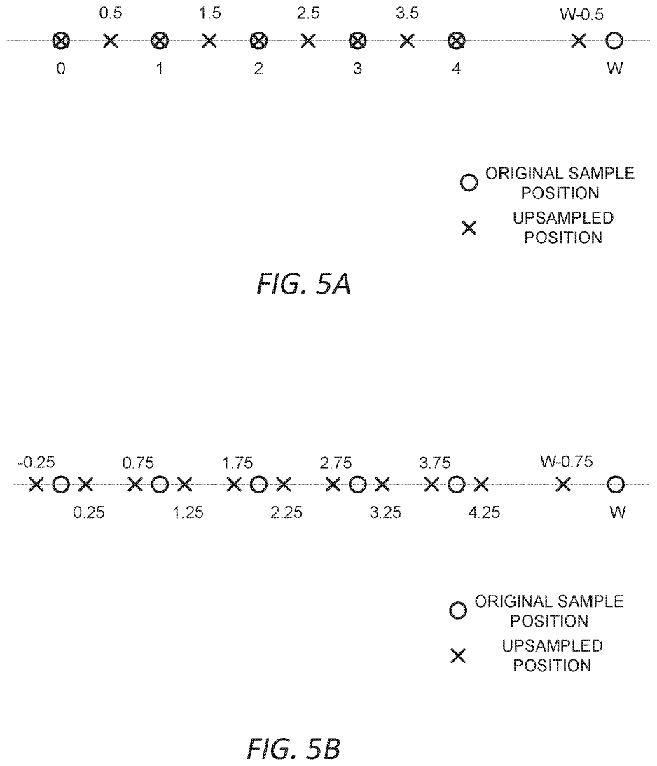

for a reference picture with original samples at i∈[0, W−1]. This example of upsampled locations is illustrated in FIG. 5A. In FIG. 5A, circles represent the original samples and crosses represent the upsampled locations. The advantage of this arrangement is that half of the samples are at the locations of the original samples (e.g., i=0, 1, . . . , W−1). As such, only the remaining half of the samples (e.g., i=0.5, 1.5, . . . , W−0.5) need to be interpolated. To interpolate the half-pel interpolated samples, the 6-tap chroma filter for the 16/32 position shown in Table 2 can be used, namely the filter with the following coefficients:

$$\{ 10 , - 40 , 158 , 158 , - 40 , 10 \} .$$

In another example of r=2, the upsampled locations along the i dimension can be at the following locations:

$$i = - 0.25 , 0.25 , 0.75 , 1.25 , … W - 1.25 , W - 0.75$$

This example of upsampled locations is illustrated in FIG. 5B. Similar to FIG. 5A, in FIG. 5B, circles represent the original samples and crosses represent the upsampled locations. The advantage of this arrangement is that the upsampled locations are symmetrically located relative to the original reference picture samples. To interpolate the quarter-pel interpolated samples, the 6-tap chroma filters for 8/32 and 24/32 positions are used, namely the following filters:

$$\{ 8 , - 35 , 227 , 73 , - 22 , 5 \}$$

$$\{ 5 , - 22 , 73 , 2 \; 27 , - 35 , 8 \}$$

In particular, the chroma filter for 8/32 position can be used to generate the interpolated samples at locations 0.25, 1.25, . . . , W−0.75; and the chroma filter for 24/32 position can be used to generate the interpolated samples at locations −0.25, 0.75, . . . , W−1.25.

Other interpolation filters may be selected depending on the value of r and the sampling convention. For example, if r=4 and the upsampled locations are at 0, 0.25, 0.5, 0.75, 1, 1.25, 1.5, 1.75 . . . , the chroma filters for the 8/32, 16/32, 24/32 positions can be used to generate the upsampled values. For instance, the chroma filter for the 8/32 position can be used to generate the upsampled values at 0.25, 1.25, . . . ; the chroma filter for the 16/32 position can be used to generate the upsampled values at 0.5, 1.5, . . . ; and the chroma filter for the 24/32 position can be used to generate the upsampled values at 0.75, 1.75, . . . .

In another example where r=1.5, the upsampled locations can be set at 0, 2/3, 4/3, 2, 8/3, 10/3, 4, . . . . In this example, the interpolation filters for different upsampled locations may be determined by identifying the chroma filters at positions closest to the fractional portion of the respective upsampled locations. For instance, for the upsampled locations at 2/3, 8/3, . . . , the chroma filter for the 21/32 position (i.e., the filter with coefficients {8, −31, 106, 204, −41, 10}) may be used because the 21/32 position is closer to 2/3 than other chroma filter positions. Likewise, for the upsampled locations at 4/3, 10/3, . . . , the chroma filter for the 11/32 position (i.e., the filter with coefficients {10, −41, 204, 106, −31, 8}) may be used because the 11/32 position is closer to 1/3 than other chroma filter positions.

In another embodiment, only portions of the reference picture may be resampled on-the-fly if they are needed for application of an inter-prediction tool. The advantage of this embodiment is the reduced resampling complexity and buffer storage.

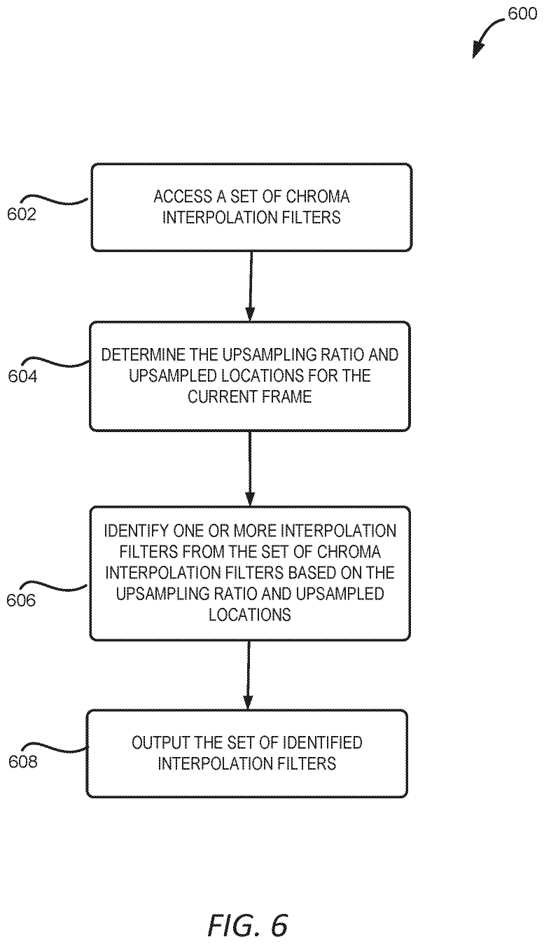

FIG. 6 illustrates an example of a process 600 for determining interpolation filters for reference picture resampling, according to some embodiments of the present disclosure. One or more computing devices (e.g., the computing device implementing the video encoder 100, the computing device implementing the video decoder 100, or another computing device) implement operations depicted in FIG. 6 by executing suitable program code.

At block 602, the process 600 involves accessing a set of chroma interpolation filters. In some examples, the set of chroma interpolation filters are used for motion compensation for a current frame. For example, the set of chroma interpolation filters can be the filters shown in Table 2, which implement interpolations in increments of 1/32 sample shift. At block 604, the process 600 involves determining the upsampling ratio r for the current frame and the upsampled locations. As discussed above, the upsampling ratio r can be determined based on the resolution of the current frame and the reference frame. For example, if the current frame has a resolution of 2 W×2H and the reference frame has a resolution of W×H, the upsampling ratio r=2. The upsampled locations may be determined based on the sampling convention and the upsampling ratio. For example, the upsampled locations may be determined to contain the original reference picture samples to reduce the number of samples to be interpolated. Alternatively, or additionally, the upsampled locations may be determined so that the upsampled locations that are symmetrically located relative to the original reference picture samples.

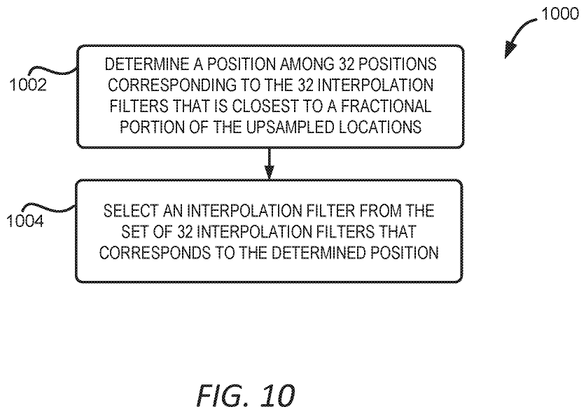

At block 606, the process 600 involves identifying one or more interpolation filters for reference picture resampling from the set of chroma interpolation filters. The identification can be performed based on the upsampling ratio and the upsampled locations determined at block 604. FIG. 10 depicts an example of a process 1000 for identifying one or more interpolation filters from a set of 32 interpolation filters based on the upsampling ratio and the upsampled locations, according to some embodiments of the present disclosure. At block 1002, the process 1000 involves determining a position among 32 positions corresponding to the 32 interpolation filters that is closest to a fractional portion of the upsampled locations. At block 1004, the process 1000 involves selecting an interpolation filter from the set of 32 interpolation filters that corresponds to the determined position. For example, the interpolation filters can be determined by identifying the chroma filters at positions closest to the respective upsampled locations. For instance, for the upsampled locations at s/t, 1 s/t, 2 s/t . . . , where s/t is the fractional portion of the upsampled locations, the chroma filter that has an associated location closest to s/t can be identified for generating upsampled values at these locations. As shown in the above examples, depending on the upsampled locations, one or more interpolation filters may be needed to generate the upsampled values at the fractional pixel locations. For upsampled locations at integer locations, such as 0, 1, 2, . . . , no interpolation filters are needed and the original sample values of the reference picture are used in the upsampled reference frame. At block 608, the identified interpolation filter(s) can be output for use in the reference picture resampling.

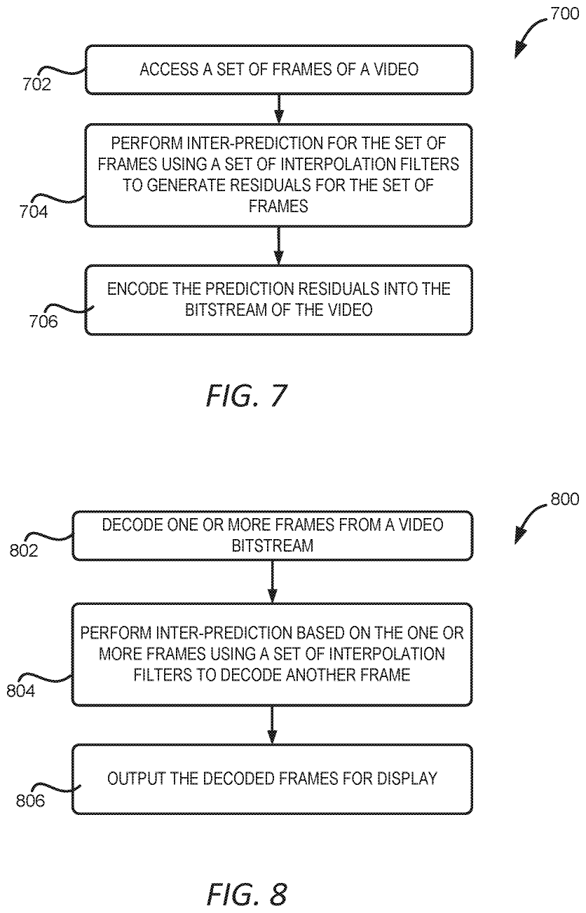

FIG. 7 depicts an example of a process 700 for encoding a video using chroma interpolation filter for reference picture resampling, according to some embodiments of the present disclosure. One or more computing devices (e.g., the computing device implementing the video encoder 100) implement operations depicted in FIG. 7 by executing suitable program code including, for example, the inter prediction module 124 and other modules. For illustrative purposes, the process 700 is described with reference to some examples depicted in the figures. Other implementations, however, are possible.

At block 702, the process 700 involves accessing a set of frames or pictures of a video signal. As discussed above with respect to FIG. 1, the set of frames of the video may be divided into blocks, such as coding units 402 discussed in FIG. 4 or any type of block processed by a video encoder as a unit when performing the inter prediction. At block 704, the process 700 involves performing inter prediction for the set of frames using a set of interpolation filters to generate prediction residuals for the plurality of frames. In some examples, the set of interpolation filters include chroma interpolation filters as shown in Table 2 that are used in the motion compensation of the chroma samples. As discussed above in detail, this set of chroma interpolation filters can be re-used for reference frame resampling. Selecting the interpolation filter(s) for reference picture resampling from the set of chroma interpolation filters can be performed according to process 600 discussed above with regard to FIG. 6. The video encoder may use the selected interpolation filter(s) to upsample the chroma component of the reference frame to calculate the inter-predicted values for a block and calculate the residual by subtracting the inter prediction from the samples of the block.

At block 706, the process 700 involves encoding the prediction residuals for the set of frames into a bitstream representing the video. As discussed above in detail with respect to FIG. 1, the encoding can involve operations such as transformation, quantization, entropy coding of the prediction residuals. The coded bits of the prediction residuals can be included in the bitstream of the video along with other data.

FIG. 8 depicts an example of a process 800 for decoding a video, according to some embodiments of the present disclosure. One or more computing devices implement operations depicted in FIG. 8 by executing suitable program code. For example, a computing device implementing the video decoder 200 may implement the operations depicted in FIG. 8 by executing the program code, including, for example, the inter prediction module 224. For illustrative purposes, the process 800 is described with reference to some examples depicted in the figures. Other implementations, however, are possible.

At block 802, the process 800 involves decoding one or more frames from a video bitstream, such as the encoded video 202. As discussed above with respect to FIG. 2, the decoding can involve entropy decoding, de-quantization, inverse transformation, and reconstructing blocks of the frames based on inter- or intra-predicted blocks. At block 804, the process 800 involves performing inter prediction based on the one or more decoded frames to decode a current frame of the video. For example, the decoded one or more frames can be used as reference frames and the inter prediction of the current frame can be performed based on the motion vectors decoded from the video bitstream and a set of interpolation filters as discussed above in detail.

In some examples, the set of interpolation filters for motion compensation include chroma interpolation filters as shown in Table 2. As discussed above in detail, this set of chroma interpolation filters can be re-used for reference picture resampling to upsample reference frames that have lower resolutions than the current frame. Selecting the interpolation filter(s) for reference picture resampling from the set of chroma interpolation filters can be performed according to process 600 discussed above with regard to FIG. 6. The video decoder can use the selected interpolation filter(s) to upsample a reference frame that has a lower resolution than the current frame prior to performing the motion compensation. At block 806, the process 800 involves decoding the rest of the frames in the video into images. In some examples, the decoding is performed according to the process described above with respect to FIG. 2. The decoded video can be output for display.

### Computing System Example

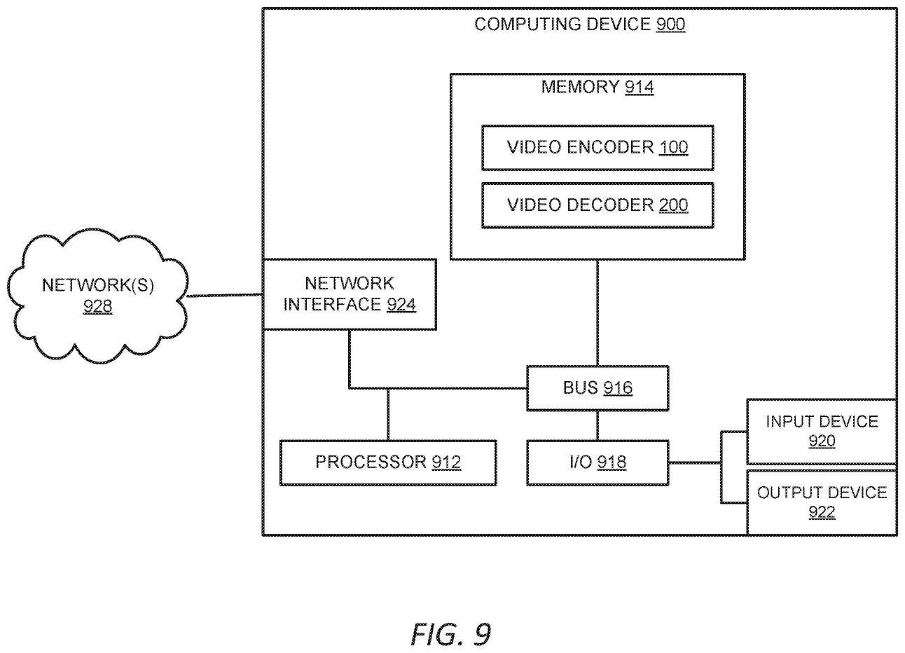

Any suitable computing system can be used for performing the operations described herein. For example, FIG. 9 depicts an example of a computing device 900 that can implement the video encoder 100 of FIG. 1 or the video decoder 200 of FIG. 2. In some embodiments, the computing device 900 can include a processor 912 that is communicatively coupled to a memory 914 and that executes computer-executable program code and/or accesses information stored in the memory 914. The processor 912 may comprise a microprocessor, an application-specific integrated circuit (“ASIC”), a state machine, or other processing device. The processor 912 can include any of a number of processing devices, including one. Such a processor can include or may be in communication with a computer-readable medium storing instructions that, when executed by the processor 912, cause the processor to perform the operations described herein.

The memory 914 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 900 can also include a bus 916. The bus 916 can communicatively couple one or more components of the computing device 900. The computing device 900 can also include a number of external or internal devices such as input or output devices. For example, the computing device 900 is shown with an input/output (“I/O”) interface 918 that can receive input from one or more input devices 920 or provide output to one or more output devices 922. The one or more input devices 920 and one or more output devices 922 can be communicatively coupled to the I/O interface 918. The communicative coupling can be implemented via any suitable manner (e.g., a connection via a printed circuit board, connection via a cable, communication via wireless transmissions, etc.). Non-limiting examples of input devices 920 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 922 include an LCD screen, an external monitor, a speaker, or any other device that can be used to display or otherwise present outputs generated by a computing device.

The computing device 900 can execute program code that configures the processor 912 to perform one or more of the operations described above with respect to FIGS. 1-8. The program code can include the video encoder 100 or the video decoder 200. The program code may be resident in the memory 914 or any suitable computer-readable medium and may be executed by the processor 912 or any other suitable processor.

The computing device 900 can also include at least one network interface device 924. The network interface device 924 can include any device or group of devices suitable for establishing a wired or wireless data connection to one or more data networks 928. Non-limiting examples of the network interface device 924 include an Ethernet network adapter, a modem, and/or the like. The computing device 900 can transmit messages as electronic or optical signals via the network interface device 924.

### General Considerations

Numerous details are set forth herein to provide a thorough understanding of the claimed subject matter. However, those skilled in the art will understand that the claimed subject matter may be practiced without these details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Some blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method for decoding a video, the method comprising:
determining one or more reference pictures for a current picture of the video;
performing inter prediction to decode the current picture of the video by using the one or more reference pictures, wherein performing the inter prediction comprises:
performing reference picture resampling by upsampling a reference picture for the current picture by using at least a filter selected from a set of interpolation filters with 6 taps for a chroma component of the video.

2. The method of claim 1, wherein the set of interpolation filters has coefficients:
{0, 0, 256, 0, 0, 0},
{1, −6, 256, 7, −2, 0},
{2, −11, 253, 15, −4, 1},
{3, −16, 251, 23, −6, 1},
{4, −21, 248, 33, −10, 2},
{5, −25, 244, 42, −12, 2},
{7, −30, 239, 53, −17, 4},
{7, −32, 234, 62, −19, 4},
{8, −35, 227, 73, −22, 5},
{9, −38, 220, 84, −26, 7},
{10, −40, 213, 95, −29, 7},
{10, −41, 204, 106, −31, 8},
{10, −42, 196, 117, −34, 9},
{10, −41, 187, 127, −35, 8},
{11, −42, 177, 138, −38, 10},
{10, −41, 168, 148, −39, 10},
{10, −40, 158, 158, −40, 10},
{10, −39, 148, 168, −41, 10},
{10, −38, 138, 177, −42, 11},
{8, −35, 127, 187, −41, 10},
{9, −34, 117, 196, −42, 10},
{8, −31, 106, 204, −41, 10},
{7, −29, 95, 213, −40, 10},
{7, −26, 84, 220, −38, 9},
{5, −22, 73, 227, −35, 8},
{4, −19, 62, 234, −32, 7},
{4, −17, 53, 239, −30, 7},
{2, −12, 42, 244, −25, 5},
{2, −10, 33, 248, −21, 4},
{1, −6, 23, 251, −16, 3},
{1, −4, 15, 253, −11, 2},
{0, −2, 7, 256, −6, 1};

3. The method of claim 1, wherein performing the inter prediction further comprises performing motion compensation for the current picture using the set of interpolation filters.

4. The method of claim 1, wherein the filter is selected from the set of interpolation filters by:
determining an upsampling ratio and upsampled locations for the reference picture; and
identifying the filter from the set of interpolation filters based on the upsampling ratio and the upsampled locations.

5. The method of claim 4, wherein identifying the filter from the set of interpolation filters based on the upsampling ratio and the upsampled locations comprises:
determining a position among positions corresponding to the set of interpolation filters that is closest to a fractional portion of the upsampled locations; and
selecting an interpolation filter from the set of interpolation filters that corresponds to the determined position.

6. The method of claim 4, wherein the upsampling ratio is 2 and the selected filter is one of {10, −40, 158, 158, −40, 10}, {8, −35, 227, 73, −22, 5}, or {5, −22, 73, 227, −35, 8}.

7. The method of claim 1, wherein the upsampled reference picture is stored in a buffer.

8. A method for encoding a video, the method comprising:
determining one or more reference pictures for a current picture of the video;
performing inter prediction to encode the current picture by using the one or more reference pictures, wherein performing the inter prediction comprises:
performing reference picture resampling by upsampling a reference picture for the current picture by using at least a filter selected from a set of interpolation filters with 6 taps for a chroma component of the video.

9. The method of claim 8, wherein the set of interpolation filters has coefficients:
{0, 0, 256, 0, 0, 0},
{1, −6, 256, 7, −2, 0},
{2, −11, 253, 15, −4, 1},
{3, −16, 251, 23, −6, 1},
{4, −21, 248, 33, −10, 2},
{5, −25, 244, 42, −12, 2},
{7, −30, 239, 53, −17, 4},
{7, −32, 234, 62, −19, 4},
{8, −35, 227, 73, −22, 5},
{9, −38, 220, 84, −26, 7},
{10, −40, 213, 95, −29, 7},
{10, −41, 204, 106, −31, 8},
{10, −42, 196, 117, −34, 9},
{10, −41, 187, 127, −35, 8},
{11, −42, 177, 138, −38, 10},
{10, −41, 168, 148, −39, 10},
{10, −40, 158, 158, −40, 10},
{10, −39, 148, 168, −41, 10},
{10, −38, 138, 177, −42, 11},
{8, −35, 127, 187, −41, 10},
{9, −34, 117, 196, −42, 10},
{8, −31, 106, 204, −41, 10},
{7, −29, 95, 213, −40, 10},
{7, −26, 84, 220, −38, 9},
{5, −22, 73, 227, −35, 8},
{4, −19, 62, 234, −32, 7},
{4, −17, 53, 239, −30, 7},
{2, −12, 42, 244, −25, 5},
{2, −10, 33, 248, −21, 4},
{1, −6, 23, 251, −16, 3},
{1, −4, 15, 253, −11, 2},
{0, −2, 7, 256, −6, 1};

10. The method of claim 8, wherein performing the inter prediction further comprises performing motion compensation for the current picture using the set of interpolation filters.

11. The method of claim 8, wherein the filter is selected from the set of interpolation filters by:
determining an upsampling ratio and upsampled locations for the reference picture; and
identifying the filter from the set of interpolation filters based on the upsampling ratio and the upsampled locations.

12. The method of claim 11, wherein identifying the filter from the set of interpolation filters based on the upsampling ratio and the upsampled locations comprises:
determining a position among positions corresponding to the set of interpolation filters that is closest to a fractional portion of the upsampled locations; and
selecting an interpolation filter from the set of interpolation filters that corresponds to the determined position.

13. The method of claim 11, wherein the upsampling ratio is 2 and the selected filter is one of {10, −40, 158, 158, −40, 10}, {8, −35, 227, 73, −22, 5}, or {5, −22, 73, 227, −35, 8}.

14. The method of claim 8, wherein the upsampled reference picture is stored in a buffer.

15. A non-transitory computer-readable medium, having a computer program and a bitstream stored thereon, wherein the computer program, when executable by one or more processing devices, enables the one or more processing devices to perform the following steps to generate the bitstream:
determining one or more reference pictures for a current picture of the video;
performing inter prediction to encode the current picture by using the one or more reference pictures, wherein performing the inter prediction comprises:
performing reference picture resampling by upsampling a reference picture for the current picture by using at least a filter selected from a set of interpolation filters with 6 taps for a chroma component of the video.

16. The non-transitory computer-readable medium of claim 15, wherein the set of interpolation filters has coefficients:
{0, 0, 256, 0, 0, 0},
{1, −6, 256, 7, −2, 0},
{2, −11, 253, 15, −4, 1},
{3, −16, 251, 23, −6, 1},
{4, −21, 248, 33, −10, 2},
{5, −25, 244, 42, −12, 2},
{7, −30, 239, 53, −17, 4},
{7, −32, 234, 62, −19, 4},
{8, −35, 227, 73, −22, 5},
{9, −38, 220, 84, −26, 7},
{10, −40, 213, 95, −29, 7},
{10, −41, 204, 106, −31, 8},
{10, −42, 196, 117, −34, 9},
{10, −41, 187, 127, −35, 8},
{11, −42, 177, 138, −38, 10},
{10, −41, 168, 148, −39, 10},
{10, −40, 158, 158, −40, 10},
{10, −39, 148, 168, −41, 10},
{10, −38, 138, 177, −42, 11},
{8, −35, 127, 187, −41, 10},
{9, −34, 117, 196, −42, 10},
{8, −31, 106, 204, −41, 10},
{7, −29, 95, 213, −40, 10},
{7, −26, 84, 220, −38, 9},
{5, −22, 73, 227, −35, 8},
{4, −19, 62, 234, −32, 7},
{4, −17, 53, 239, −30, 7},
{2, −12, 42, 244, −25, 5},
{2, −10, 33, 248, −21, 4},
{1, −6, 23, 251, −16, 3},
{1, −4, 15, 253, −11, 2},
{0, −2, 7, 256, −6, 1};

17. The non-transitory computer-readable medium of claim 15, wherein performing the inter prediction further comprises performing motion compensation for the current picture using the set of interpolation filters.

18. The non-transitory computer-readable medium of claim 15, wherein the filter is selected from the set of interpolation filters by:
determining an upsampling ratio and upsampled locations for the reference picture; and
identifying the filter from the set of interpolation filters based on the upsampling ratio and the upsampled locations.

19. The non-transitory computer-readable medium of claim 18, wherein identifying the filter from the set of interpolation filters based on the upsampling ratio and the upsampled locations comprises:
determining a position among positions corresponding to the set of interpolation filters that is closest to a fractional portion of the upsampled locations; and
selecting an interpolation filter from the set of interpolation filters that corresponds to the determined position.

20. The non-transitory computer-readable medium of claim 18, wherein the upsampling ratio is 2 and the selected filter is one of {10, −40, 158, 158, −40, 10}, {8, −35, 227, 73, −22, 5}, or {5, −22, 73, 227, −35, 8}.
